(19) United States
(12) Patent Application Publication
(10) Pub. No.: US 2015/0321466 A1
(43) Pub. Date: Nov. 12, 2015

(54) DEVICE FOR SUPPLYING A FLUID TO BE DEPOSITED, PROVIDED IN MACHINES FOR DEPOSITING A FLUID ON A SUBSTRATE VIA A SUPPLY CYLINDER

(71) Applicant: LR CONVERTING PERIPHERAL PRODUCTS, S.L., Cornella del Terri (Girona) (ES)

(72) Inventor: Ramon Serratosa Jorda, OLOT ( GIRONA ) (ES)

(21) Appl. No.: 14/652,019

(22) PCT Filed: Dec. 5, 2013
(86) PCT No.: PCT/ES2013/070853

§ 371 Date: Jun. 12, 2015

(30) Foreign Application Priority Data
Dec. 14, 2012 (ES) P201231944

(51) Int. Cl. B41F 31/08

(52) U.S. Cl. CPC B41F 31/08

(57) ABSTRACT

The invention relates to a device for supplying a fluid to be deposited, provided in a machine for depositing a fluid on a substrate via a supply cylinder, of the type that comprises a supply circuit with a pump for supplying ink to a first rotating roller of the flexographic printer, characterised in that said pump is a reversible-volumetric-type pump that pumps a constant volume of fluid in each cycle.

The present invention relates to systems for supplying a fluid in machines for depositing fluid on a substrate via a supply cylinder, and more specifically to the ink supply control device of the type with which said machines, such as flexographic printers, rotogravure printers, laminators, etc. must necessarily be provided.

Flexography is a printing technique in relief invented in 1905 by the Frenchman, Houleg. It is characterised in that the printing plate is flexible and is therefore capable of adapting to varied supports.

Rapid ink drying is a requirement of this technique, which makes careful selection of inks, control of the conditions thereof and possibly the provision of ink drying elements necessary.

Flexographic printers are usually rotary. One difference from other printing systems is the way in which the printing plate receives the ink. A rotating roller, usually made of rubber, receives the ink from the control system, either directly from the ink reservoir or through a pumping circuit which takes the ink from the reservoir to the rotating roller using rotary or pneumatic ink pumps. This rotating roller transfers said ink by contact to another engraved roller, usually known as the anilox roller. The anilox roller has microcells with which the level of ink transferred to the printing plate is controlled.

If the rotating roller receives the ink from a pumping circuit with rotary pumps, an ink return circuit is also provided, usually to the ink reservoir.

The advantage of supplying the first rotating roller from an ink pumping circuit is that the circuit can be used not only for inking the roller, but also for automatically cleaning the machine, by causing solvents to pass through the pumping circuit. Solvent can also be added to the circuit for on-line control of the ink viscosity.

Another basic requirement from a practical point of view is that the supply system should be able to function in reverse, that is to say, reversing the flow direction of the fluid or ink, to allow correct emptying.

It will be clear that the ink transfer system requires that the physical properties of the ink be strictly controlled. In particular, and among other parameters, it is necessary to check, monitor and control the viscosity of the ink.

However, measuring viscosity is complex from a technical point of view. Because viscosity is a parameter that cannot be measured directly, but only indirectly, measurement is complicated, somewhat unreliable, not easily repeated and dependent on the measurement device. Consequently, on-line viscosity measurement devices for flexographic machines are delicate, expensive and require complicated electronics and/or software. According to techniques known at present in the sector, the most reliable viscosity measurement system for these applications is the system based on measurement of a falling body, known as a torpedo, in the ink that is to be checked.

Two magnetic sensors detect the fall of the torpedo through the body of a tube full of ink and the time taken determines the viscosity values.

Depending on the measured viscosity, a programmable logic controller (PLC) decides the amount of solvent to be added to the ink, should this be necessary.

The present invention discloses a novel ink supply and control system for flexographic printers which has the advantage, if required, of allowing the measurement and control of the ink viscosity in a more reliable, effective and economical way than in the known systems.

In particular, the device disclosed by the present invention is an ink control device for a printing machine of the type that comprises a supply circuit with a pump for supplying ink to a first rotating roller of the flexographic printer, characterised in that said pump is a volumetric-type pump which propels a constant volume of ink in each cycle.

The present invention is based on replacing the conventional rotary pump with a volumetric pump. Volumetric pumps are the most widely known in the sector. Said pumps are classified into two sub-types, reciprocating piston pumps and static rotary pumps (such as lobe, gear, screw or peristaltic pumps).

Some of these types of pumps are reversible by construction (such as lobe or gear pumps, for example), others can have a reversible construction if express provision is made for said possibility during the construction thereof (in the case of piston pumps, for example).

Preferably, the volumetric pump will be a positive displacement pump by means of rotating elements with a surface made of an anti-abrasion material (a plastics material, for example) to avoid seizing, and with magnetic drive (to avoid fluid leaks).

In principle, bearing in mind the conditions of use of the pump, and in accordance with general engineering criteria, ink propulsion systems should use rotary or diaphragm pumps, as do the present known systems.

However, according to the present invention, modern volumetric pumps can be produced for use in said systems and have the advantage of being able to maintain a very constant flow over time as, at each cycle, volumetric pumps propel a constant volume.

Although rotary pumps provide an output with sufficiently small variations for correct operation of the flexographic printer, the greater capacity of volumetric pumps to propel a constant volume allows more economical and reliable measurement of the properties of the fluid to be deposited.

Thus, if the flow is assumed to be constant, the difference in load between two points of a pipe depends on the viscosity of the fluid that circulates through the pipe, which can be determined using hydrodynamic equations. That is to say, assuming a constant flow, the viscosity can be measured by determining the fall in pressure between two points of the circuit. However, the calculation is very sensitive to any small variations in flow, the variations caused by rotary and diaphragm pumps being too great to provide the required precision. Consequently, the machines require accurate viscosity measurement, which as is well known, is problematic. According to the present invention, no viscosity measurement is necessary to control the system.

The extreme precision of the flow delivered by positive displacement pumps allows said viscosity control to be dispensed with, alternatively controlling pressure, pressure differential, temperature, etc.

According to the present invention, positioning another volumetric pump in the return zone of the propulsion circuit can increase precision still further. In this way, any variations introduced by the operation of the rotating rollers (anilox) of the flexographic printer are eliminated.

As indicated earlier, for measuring viscosity, a pressure sensing system could be used to determine the pressure between two points of the circuit, preferably two points downstream of the volumetric pump of the propulsion circuit.

For a better understanding of the invention, the accompanying drawing shows an embodiment of the present invention given as an explanatory, but non-limiting example.

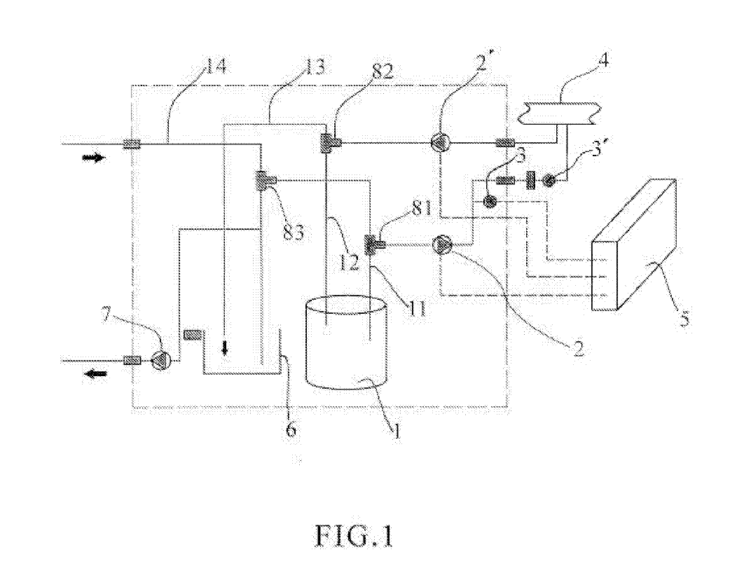

FIG. 1 is a diagram of a possible embodiment of the device, according to the present invention.

A possible embodiment of the device of the present invention is shown diagrammatically in FIG. 1, which does not show the flexographic printer, but only the scraper -4- to which the ink propulsion circuit -11- delivers ink and from which an ink suction circuit removes ink and returns said ink to the reservoir -1-.

The system takes ink from the reservoir -1-, propels it by means of the constant flow volumetric pump -2- and delivers said ink to the scraper -4- of the propulsion system through the propulsion circuit. The suction circuit -12- also has a constant-output volumetric pump -2′-.

The pumps -2-, -2′- can be properly synchronised by means of speed variators, which allows the ink flow to be adjusted to the speed of the printer or, which is the same thing, depending on the ink consumption of the scraper -4-.

Viscosity is controlled by means of a pressure sensing system -3-, -3′- which delivers data to the PLC -5- which performs the necessary operations, and acts appropriately on the system, (modifying the speed of the pumps -2-, -2′-, -7′-, actuating the valves -81-, -81-, -83-, -84-, for the addition of solvent, etc.).

The pressure sensing system -3- is preferably situated upstream of the volumetric pump -2- of the propulsion system -11-. The number of pressure sensors may vary.

The system is completed by an inlet -14- for clean solvent, a reservoir -6- for dirty solvent and a suction pump -7- for dirty solvent, as well as valves -82-, -83-, -81- which allow the addition of solvent to the ink flow or the cleaning of the system by circulating solvent through the propulsion -11- and suction -12- circuits.

Although the invention has been described with respect to preferred embodiments, these should not be considered as limiting the invention, which will be defined by the widest interpretation of the following claims.

1. Device for supplying a fluid to be deposited in machines for depositing fluid on a substrate via a supply cylinder of the type that comprises a supply circuit with a pump for supplying ink to a first rotating roller of the flexographic printer, wherein said pump is a reversible volumetric-type pump which propels a constant volume of ink in each cycle.

2. Device according to claim 1, it wherein the device has another volumetric pump in the return zone of the propulsion circuit, the movement of said pumps being synchronised.

3. Device according to claim 1, it wherein the device has a differential pressure sensing system to determine the variation in pressure between two points of the circuit.

4. Device according to claim 3, wherein the sensing system calculates the difference in load between two points downstream of the volumetric pump of the propulsion circuit.

5. Device according to claim 1, wherein the pump or pumps are pumps with an impeller or impellers made of a plastic material.

6. Device according to claim 1, wherein the pump or pumps have a magnetic drive to prevent fluid leaks.

7. Device according to claim 1, wherein the fluid comprises ink and the machine for depositing fluid on a substrate is a flexographic printer.

8. A method for supplying an ink, comprising:
propelling a constant volume of the ink in each cycle from a reversible volumetric-type pump;
supplying the ink to a first rotating roller of a flexographic printer; and
depositing fluid on a substrate via a supply cylinder.
